(19) United States
(12) Patent Application Publication
(10) Pub. No.: US 2008/0161629 A1
(43) Pub. Date: Jul. 3, 2008

(54) Radioactive waste processing

(76) Inventors: Oleg Naljotov, Brooklyn, NY (US); Vladimir Zorev, Arsenyev (RU)

Correspondence Address: Oleg NALJOTOV;Apt# 5D, 3130 Brighton 6th Street, Brooklyn, NY, 11235, US

(21) Appl. No.: 11/649,017

(22) Filed: Jan. 3, 2007

(51) Int. Cl. G21F 9/00; B01L 11/00

(52) U.S. Cl. 588/18; 588/1; 422/101

(57) ABSTRACT

An improved radioactive waste (RW) processing is usable, e.g., for reducing radioactivity of wastes produced by nuclear plants. The processing comprises an entry and a base stages. The entry stage is exemplified either by a “standard” option or an “own” option encompassing the grinding RW and obtaining a pulp. Both the options provide technological mixture for the base processing, which encompasses intermingling the mixture with predetermined substances, kneading and filtering the mixture, removing wastes, processing the mixture in either a regular or in a special dissolver, or in both. The resulted product is subjected to rotation in a special centrifuge utilizing the Searl effect that allows further reducing the RW radioactivity. The so treated RW is then packed into specially constructed glass containers, or compressed and covered by special glass-mass. Composition and processing instructions for the substances and glass-mass, and the constructions of the special dissolver and centrifuge are disclosed.

### TECHNICAL FIELD

The present invention relates to radioactive waste processing technologies, particularly to chemical and physical processing of radioactive waste prior to placing it into storage.

### BACKGROUND OF THE INVENTION

At present about 50,000 tons of nuclear reaction products, necessary for further processing and burring, are accumulated in various storages of atomic power plants in the world. Nuclear reactions usually consume from 0.5% to 3.5% of the nuclear fuel, and the rest goes into waste including nuclear fission products, such as cesium and strontium, which waste cannot be terminated, but can be “infinitely” kept in special storage. According to conventionally known requirements for radioactive safety and environment protection, a long-term storage and burring of the nuclear waste is permitted only after appropriate chemical processing.

However, the modern technology of conversion, concentration, removal, and burring of radioactive waste (RW), satisfying the aforesaid requirements, is the least developed stage in the whole nuclear fuel cycle. The RW to be burred is typically placed into special containers. The final stage of operation with the RW is burring of the containers in geologic formations that are considered a major protective barrier of such burring. This is because the construction materials and materials of the containers' shells, usually utilized in the burring structures, cannot provide reliable protection of the environment from penetration of “long-living” radioactive elements.

Usually, a geologic RW storage is a complicated engineering construction disposed more than 60 meters under the ground level. The storage includes a burring space with a floor. Bore pits are drilled in the floor to store containers with RW of high specific radioactivity. A distance between the bore pits must be from 10 to 50 meters to satisfy the heat-withdrawal regime from the containers to avoid a nuclear disaster.

Such geologic storage is characterized in that mining rocks of the formations are intensely affected by a powerful ionizing radiation field with high temperatures. Interaction of the radiation with the geologic rocks results in reduction of the radiation field, but also in radiation defects in the material structure of the rocks, involving energy accumulation in the radiated material and a local temperature increase. Such processes, being accumulated, may alter natural properties of the rocks surrounding the RW, cause phase transitions, lead to emission of gases, and influence the structural integrity of the storage walls.

### BRIEF SUMMARY OF THE INVENTION

The proposed technology of RW processing allows decreasing the impact of the radiation field onto the geologic formations and containers' materials, and provide a higher safety level of the environment. It also allows reducing the RW's heat generation rate; allows storing the RW in a temperature range of substantially from +2.degree.C to +60.degree.C; simplifies the storage arrangement by enabling to place the RW in piles substantially without mass limitations, rather than in aforesaid containers and bore pits; or otherwise at least significantly reduces the distance between the bore pits satisfying required heat-withdrawing regimes; extends the storage term up to 70-80 years, until the RW will be finally burred after a special processing with the use of a special centrifuge. This reduces the expenses to build and maintain long-term storage structures by minimum two times.

Some of the most effective applications of the proposed technology are usable during the processing of radioactive and/or toxic deposits in reservoirs for storage of liquid radioactive and industrial wastes: water, water-recycling, and water-cleaning reservoirs, e.g. cooling pools and sedimentation ponds of atomic power plants.

The proposed RW processing technology comprises the steps of mixing RW and/or toxic waste with mineral and salts additives partially absorbing neutrons; heating up the mixture; and exposing the mixture until formation of a final product—a solid matrix.

A distinct feature of the technology is that the mineral and salts additives are used in the forms of glass-forming and glass-modifying materials at a certain proportion of components depending on the radioactive deposits mass. The use of glass containers for RW storage allows enlarging the volume of stored RW without additional requirements to storage areas, since the intenseness of influence (ionizing radiation and high temperature) onto geologic rocks is reduced. The interaction of the weakened radiation with the materials of geologic formations slows down the growth of their structural radiation defects, which defects lead to accumulation of energy in the material subjected to the radiation and to a local temperature increase.

The glass-forming materials used in the technology are essentially compounds of (a) silicon, including: quartz or river sand, silica gels, alkali metal silicate; (b) boron, including: concentrated datolit, alkali and alkaline-earth element borates, boric acid; and (c) mineral or synthetic alumino-silicates, including: zeolites, argillous materials, bentonite, vermiculite, clinoptilolite. Additionally the glass-forming materials may be represented by: utilized sorbents based on silica-gels and based on mineral or synthetic alumino-silicates.

The glass-modifying materials used in the technology are essentially alkali metal salts, including: nitrates, carbonates, oxalates and their mixtures, salt deposit of vaporized concentrates of liquid radioactive wastes produced by nuclear power plants and special plants processing radioactive and industrial toxic wastes.

The proposed processing technology additionally comprises the steps of processing the mixture in a high-velocity centrifuge in a specially induced electro-magnetic field. The centrifuge processing produces an effect of reducing radioactivity of subjected materials (the mixture) due to internal atomic processes. The effect was discovered by a British inventor John Searl in 1967 in Berkshire County (Great Britain) during testing of his generator (Searl Effect). The Searl generator had an immovable ring surrounded by magnetic rolls, which were revolving around the ring's axis, and simultaneously around their own axes. The Searl generator was considered as a new energy source. A test of a strontium-90 sample, placed for 10 minutes inside the Searl generator, showed a decrease of its radioactivity.

The proposed technological solutions allow reducing the specific radioactivity of the processed RW by 20%. The technology is less energy consuming, less expensive, and makes the process more efficient comparing to conventionally used RW processes.

### BRIEF DESCRIPTION OF DRAWINGS

FIG. 1 illustrates a schematic view of a special centrifuge for RW processing, according to an embodiment of the present invention.

FIG. 2 illustrates a schematic view of a special dissolver for RW processing, according to an embodiment of the present invention.

FIG. 3 illustrates a flowchart for the proposed base RW technological processing, according to an embodiment of the present invention.

FIG. 4 illustrates a flowchart for a standard processing of radiated nuclear fuel utilized as a first optional entry process to the proposed RW base technological processing, according to an embodiment of the present invention.

FIG. 5 illustrates a flowchart for a proposed radiated nuclear fuel or other RW processing utilized as a second optional entry process to the proposed base RW technological processing, according to an embodiment of the present invention.

Similar reference numerals on the drawings generally refer to the same or similar elements. A newly introduced numeral in the description is enclosed into parentheses.

### PREFERRED EMBODIMENTS OF THE PRESENT INVENTION

While the invention may be susceptible to embodiment in different forms, there are shown in the drawings, and will be described in detail herein, specific embodiments of the present invention, with the understanding that the present disclosure is to be considered an exemplification of the principles of the invention, and is not intended to limit the invention to that as illustrated and described herein.

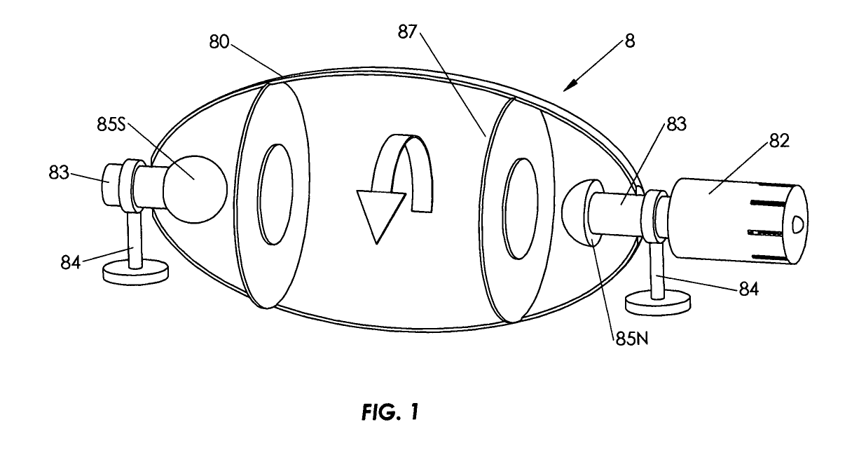

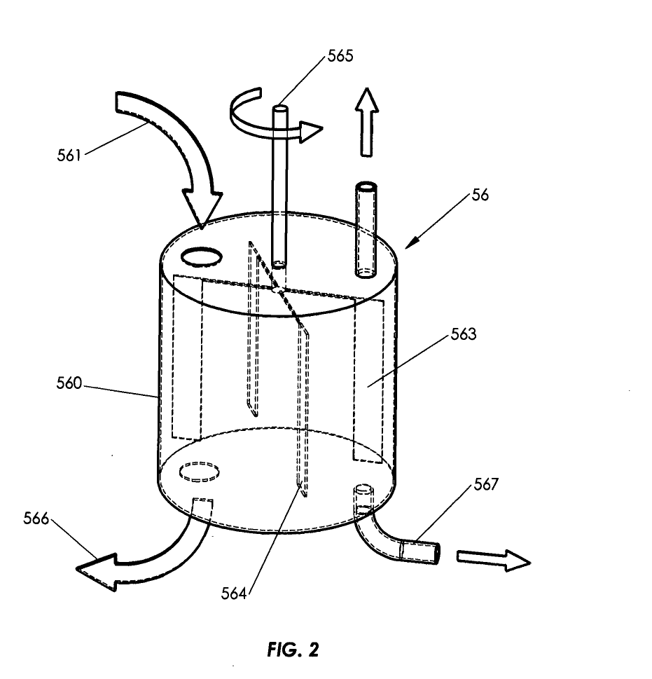

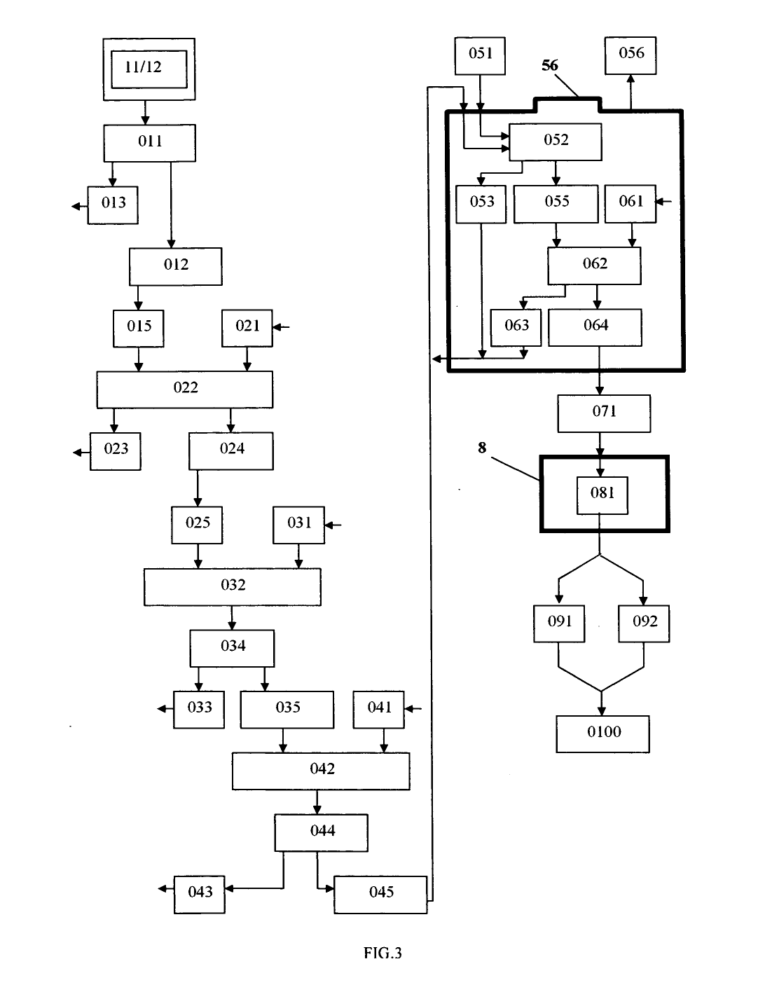

The proposed base technology of RW processing (BRWT) preliminary intermingles the RW with substances partially absorbing neutrons, in a vessel called a dissolver (herein further referred to as a regular dissolver—i.e. a vessel made of appropriate materials suitable for physical and chemical processes described herein, not illustrated) or a special dissolver (referenced as 56, illustrated on FIG. 2). The whole process may take place in either the regular or the special dissolver. A third variation is the use of the regular dissolver for steps (11/12—045 shown on FIG. 3), and the use of the special dissolver 56 (shown on FIG. 2 and FIG. 3) for steps (051-064). Said steps are followed by a processing (step 081) in a special high velocity centrifuge (8) illustrated on FIG. 1 in a specially induced electromagnetic field described further. Thereafter, a fixing stage of the processing (either step 091 or step 092, followed by step 0100) provides fixing the resultant products in a stable solid matrix or the products are packed in mini-containers made of a glass-mass, and thereafter the products are placed into storage.

The stable solid matrix may be performed from plastic materials immediately prior to placing the RW in, or prepared in advance from glass-forming components, capable of partial absorbing neutrons, and glass-modifying components. The glass-forming materials used in the BRWT are essentially compounds of (a) silicon, including: quartz or river sand, silica gels, alkali metal silicate; (b) boron, including: concentrated datolit, alkali and alkaline-earth element borates, boric acid; and (c) mineral or synthetic alumino-silicates, including: zeolites, argillous materials, bentonite, vermiculite, clinoptilolite. Additionally the glass-forming materials may be represented by: utilized sorbents based on silica-gels and based on mineral or synthetic alumino-silicates.

The glass-modifying materials used in the BRWT are essentially alkali metal salts, including: nitrates, carbonates, oxalates and their mixtures, salt deposit of vaporized concentrates of liquid radioactive wastes produced by nuclear power plants and special plants processing radioactive and industrial toxic wastes.

### The Equipment

Special dissolver 56, reflected on FIG. 2, comprises a preferably cylindrical casing (560), a first pair of blades (563) capable to revolve around an axis (565), a second pair of blades (564) capable to revolve around axis 565. First pair of blades 563 and second pair of blades 564 are vertically disposed in planes perpendicular to each other. Blades 563 and 564 include electro-conducting wires disposed along the perimeter of each blade. The wires are connected to electric current sources so that electromagnetic fields surrounding the blades are created inside dissolver 56. The electromagnetic fields affect the internal nuclear processes and the structure of radioactive materials placed in dissolver 56, thereby reducing their radioactivity. Casing 560 includes an input opening (561) for loading the RF and other components, an output opening (566) for unloading the RF and the other components, a gaseous waste outlet (562), a liquid fraction outlet (567).

Special high velocity centrifuge 8, reflected on FIG. 1, comprises a casing (80), preferably shaped as an ellipsoid, attached to two immovable semi-shafts (83) positioned along the horizontal axis of the ellipsoid, which casing 80 is rotatably coupled with bearings (84) mounted on the ground. Substances subjected to processing in centrifuge 8 are loaded into casing 80. Casing 80 is rotatably coupled to semi-shafts 83 and capable to revolve around the horizontal axis with the semi-shafts. At least one of semi-shafts 83 is coupled to an electromotor (82) fed by a suitable electric source means. Two internal magnetic means (85S) and (85N), preferably electromagnets, are mounted inside casing (80), preferably along the horizontal axis, facing each other with opposite polarities, so that magnetic means 85S and 85N disposed immovable relatively to the ground (for example, the magnetic means may be coupled to the outer immovable rings of the bearings, whereas the semi-shafts are coupled to the inner revolving rings of the bearings). Two partitions (87) are installed inside casing 80 separating internal magnetic means 85N and 85S from the substances subjected to the processing in centrifuge 8.

The rotation velocity of centrifuge 8 should be substantially about 16000 rounds per minute. The volume of casing 80 should allow processing a non-critical mass of RW. The duration of processing is at least 60 minutes without acceleration and deceleration time. The processing in centrifuge 80 is based on the Searl Effect mentioned above. Chemical and physical properties of a sample placed inside centrifuge 8 are altered during its interaction with the magnetic field therein. In particular, the radioactivity of the nucleus reduces.

### Entry Processing Options

The proposed BRWT processing may be independently implemented with its own optional entry processing (an “own” option), or with another optional entry consisting of conventionally used (“industry standard”) methods for processing of nuclear fuel waste (a “standard” option). Such standard methods usually include dissolution of radiated nuclear fuel in nitrate acid followed by extraction of uranium, plutonium, and atomic fission products by dissolution performed in an equipment for processing of liquid wastes, containing the fission products, until their transformation into a form suitable for long-term storage and burring of the liquid wastes.

### The “Own” Entry Option

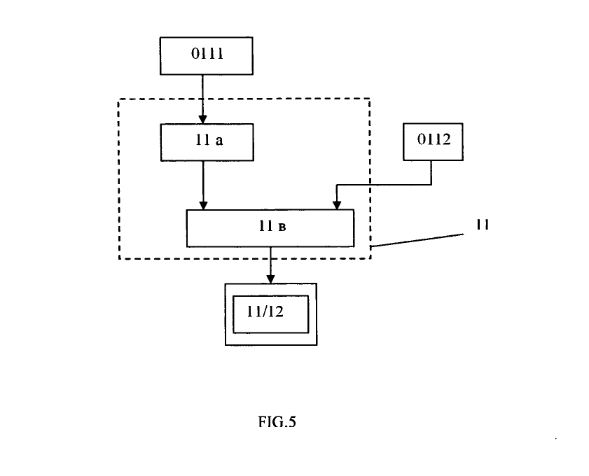

The “own” option is illustrated on FIG. 5 with a dashed rectangle (11). This proposed method embodiment comprises: a providing of radiated nuclear fuel (0111) further processed in a step (11a) of pounding the fuel 0111 into an essentially uniformed mixture comprising grains with a diameter substantially not greater than 1 mm. The mixture is then processed in a step (11b) with adding of water (0112) and obtaining a pulp (the water proportion is determined experimentally). The resultant mixture enters the basic process according to a step (11/12).

### The “Standard” Entry Option

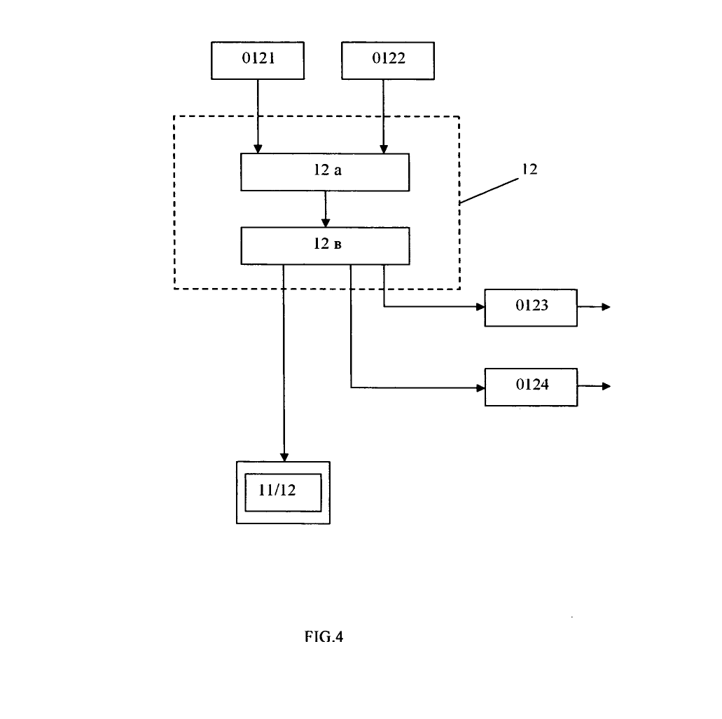

The “standard” option method embodiment includes a first entry portion processing illustrated on FIG. 4 within a dashed rectangle (12), and the proposed BWRT illustrated on FIG. 3. The technological “standard” scheme shown on FIG. 4 comprises providing of RW (0121)—crumbled up nuclear fuel to be processed in a dissolver (not shown) receiving RW 0121. The dissolver must be safe in compliance with the criticality requirement and must be capable to withstand hot highly corrosive liquids, to be remotely loaded and maintained. The RW 0121 material is dissolved in nitrate acid (0122) that is added into the dissolver, according to a step (12a).

The step (12b) provides a separation of uranium and plutonium, dissolved in the nitrate acid, from highly radiated fission products and trans-uranium elements through extraction by said dissolvent, wherein the remaining fragments of fuel elements' shells (0123) are output from the technological flow. Liquid wastes (0124) are also removed. This extraction step forms three major technological liquid flows:

(a) A solution of pure uranium nitrate, concentrated by evaporation and followed by de-nitration, wherein it transforms into uranium oxide. The oxide can be repeatedly utilized in the nuclear fuel cycle.

(b) A solution of pure plutonium nitrate, concentrated and kept until next stages of the technological process. In particular, the reservoirs for keeping plutonium solutions are constructed so that to avoid problems related to the criticality that might be raised due to changes in concentration or form of the flow.

(c) A solution of highly radioactive fission products, usually concentrated by evaporation and kept in the form of concentrated liquid. This concentrate may subsequently be evaporated or be transformed into a form suitable for storage or burring. This technological flow enters the basic process according to a step (11/12), to be used in the base inventive technology—BRWT.

The proposed BRWT therefore utilizes either the resultant product of step 12b (FIG. 4) or of step 11b (FIG. 5), united in the entry step 11/12. The solid fraction of the resultant product is evaporated and intermingled with substances partially absorbing neutrons in a standard (not illustrated) or a special dissolver shown on FIG. 2.

### The Based RW Processing Technology

The BRWT, schematically depicted on FIG. 3. It should be noted that steps from 11/12 to 045 may be accomplished in the regular dissolver or in special dissolver 56 (shown as a bold solid box on FIG. 3, and illustrated on FIG. 2). Steps from 051 to 064 should be completed in special dissolver 56, according to FIG. 3. The third variation (less expensive, though less effective in reducing radiation), where the steps from 11/12 to 064 may be completed in the regular dissolver, is not illustrated.

The BRWT comprises a step (011) of drying the introduced mixture from 12b or 11b until complete moisture removal. It facilitates a step (013)—partial volatilization of compounds and admixtures, partially decomposed by high temperature and by excessive moisture containing these harmful admixtures. So that the gaseous wastes are removed in step 013. The so processed mixture undergoes a step (012)—the crumpling up to grains substantially of about a 5 mm diameter, producing a resultant mixture (015).

Adding milk of lime will cause partial neutralization of acid medium, and formation of a tiny-dispersed and low-active fraction of RW (suspended particles) that will be removed during a further filtration. Therefore, each one mass unit of mixture 015 is intermingled with one mass unit of 3% solution of Ca(OH)₂ and further kneaded during substantially one hour in a step (022), and the resultant flow undergoes a filtration step (024) producing liquid wastes (023) and a filtered mixture (025).

Each one mass unit of filtered mixture 025 is then intermingled with 2 mass units of a 6% water solution of B₂O₃ (031) and further kneaded during substantially one hour in a step (032). The adding of boric anhydride 031 (alpha B₂O₃, which is easy dissolved in water) causes a formation of a tiny-dispersed and low-active RW fraction in the form of more stable compounds of actinides with multi-variant compounds of boron, nitrogen, and other reagents, which RW fraction may be output while dehydrated and filtrated (including in the form of depositing).

A next filtration step (034) produces liquid wastes (033) and a filtered mixture (035). Filtered mixture 035 is thereafter completely covered by a 1% solution of chloride of lime Ca(OCl)₂, CaCl₂, Ca(OH)₂ (041) and kneaded during substantially one hour in a step (042). The adding of the chloride of lime causes a formation of a tiny-dispersed and low-active RW fraction in the form of more stable compounds of actinides with multi-variant compounds of active chlorine, which RW fraction may be output while dehydrated and filtrated.

A next filtration step (044) produces liquid wastes (043) and a filtered mixture (045) shown on FIG. 3. Filtered mixture 045 is thereafter introduced into special dissolver 56, described above (illustrated on FIGS. 2, 3).

Mixture 045 is then intermingled with a 3% water solution of H₃BO₃ (051) in a one-to-one proportion. The adding of ortho-boric acid (the boron compounds catch neutrons, since boron is a donor of protons) stabilizes a portion of the RW, facilitating a transformation of the reagents into more stable products. A next step (052) comprises a kneading the new mixture in dissolver 56 with blades 563 and 564 surrounded by magnetic fields mentioned hereinabove (FIG. 2), from 1.5 to 2.0 hours, while keeping the pressure lower than 10 atmospheres. This produces liquid wastes (053), which exit dissolver 56 through liquid fraction outlet 567, and a resultant product (055), schematically depicted on FIG. 3.

One mass unit of product 055 is thereafter intermingled with a half mass unit of a 5% water solution of HF—hydrogen fluoride (061), and, according to a next step (062), the mixture is kneaded from 2.5 to 4.0 hours with a maximum pressure limitation of 20 atmospheres. The adding of hydrogen fluoride facilitates a formation from the remaining unstable reagents more stable compounds with fluorine. Step 062 results in liquid wastes (063) exiting dissolver 56 through liquid fraction outlet 567, and in a technological flow product (064). All gaseous wastes (056) (shown on FIG. 3) formed in dissolver 56, leave it through gaseous waste outlet 562 (shown on FIG. 2) described above.

Technological flow product 064 is subjected to drying and grinding to grains of a size substantially less than 1 mm, according to a step (071), and then is introduced into special centrifuge 8 (described hereinabove and depicted on FIGS. 1, 1A, and on FIG. 3 as a bold solid box), wherein it's being processed while the centrifuge is rotated with a velocity of substantially about 16000 rounds per minute during at least 1 hour, not counting the acceleration and deceleration time.

The so treated RW technological product is then conveyed to either a packaging step (091) or to a packaging step (092) illustrated on FIG. 3. Step 091 comprises placing the RW product into glass blocks with the inner dimensions of 50×100×150 mm; step 092 comprises compression the RW product into blocks of the same dimensions followed by covering by a glass-mass or epoxy resin with a layer of at least 3 mm thickness.

The blocks resulted from step 091 or step 092 can be stored according to a step (0100), shown on FIG. 3, without storage volume limitations under a temperature from +2.degree.C to +60.degree.C and kept in the storage at least 70-80 years. The steps enable separating the RW from the packaging means, and further dipper processing them.

We claim:

1. A method for processing of radioactive waste, reducing the radioactivity of said radioactive waste, comprising the acts of:
entry stage processing; and
base stage processing.

2. The method according to claim 1, wherein said entry stage processing comprising the acts of:
providing radioactive waste (0121);
providing nitrate acid (0122);
dissolving (12a) radioactive waste in the nitrate acid;
extracting (12b) uranium and plutonium from fission products and trans-uranium elements dissolved in the nitrate acid;
removing the remaining fragments of fuel elements' shells (0123) and liquid wastes (0124); and
obtaining a mixture of fission products (11/12).

3. The method according to claim 1, wherein said entry stage processing comprising the acts of:
providing radioactive waste (0111);
pounding the radioactive waste into an essentially uniformed mixture (11a);
adding water (0112) to the mixture and obtaining a pulp (11b); and
obtaining a mixture of fission products (11/12).

4. The method according to claim 2, wherein said base stage processing comprising the acts of:
introduction of the processed mixture of fission products (11/12);
drying the processed mixture (011);
removing of gaseous wastes (013) from the processed mixture;
crumpling up the processed mixture to grains substantially of a predetermined size range, obtaining a processed mixture (015);
intermingling the processed mixture with an equal mass of 3% solution of Ca(OH)₂ (021) and kneading it during substantially one hour (022);
filtering the processed mixture (024);
removing liquid wastes (023);
obtaining a filtered processed mixture (025);
intermingling each one mass unit of the filtered processed mixture with two mass units of a 6% water solution of B₂O₃ (031) and kneading the processed mixture during substantially one hour (032);
filtering the processed mixture (034);
removing liquid wastes (033);
obtaining a filtered processed mixture (035);
completely covering the filtered processed mixture the by a 1% solution of chloride of lime Ca(OCl)₂, CaCl₂, Ca(OH)₂ (041) and kneading the mixture during substantially one hour (042);
filtering the processed mixture (044);
removing liquid wastes (043);
obtaining a filtered processed mixture (045);
intermingling the filtered processed mixture with a 3% water solution of H₃BO₃ (051) in a one-to-one proportion and kneading the mixture from 1.5 to 2.0 hours, while keeping the pressure lower than 10 atmospheres (052);
removing liquid wastes (053);
obtaining a product (055);
intermingling each one mass unit of the product with a half mass unit of a 5% water solution of HF (061), and kneading it from 2.5 to 4.0 hours with a maximum pressure limitation of 20 atmospheres (062);
removing liquid wastes (063);
obtaining a technological product (064);
drying the technological product and grinding it to grains of a predetermined size range (071);
introducing the technological product into a special centrifuge means;
processing the technological product in the special centrifuge means being rotated with a velocity of substantially about 16000 rounds per minute during at least 1 hour, not counting the acceleration and deceleration time;
either placing the technological product into glass blocks with the inner dimensions substantially of 50×100×150 mm (091), or subjecting the technological product to compression into blocks with the inner dimensions substantially of 50×100×150 mm followed by covering by a glass-mass or epoxy resin with a layer of at least 3 mm thickness (092); and
placing in storage the blocks resulted from steps (091) or (092) for at least 70-80 years substantially without storage volume limitations under a temperature from +2.degree.C to +60.degree.C.

5. The method according to claim 4, wherein
the steps from (011) to (064) accomplished in a regular dissolver means.

6. The method according to claim 4, wherein
the steps from (011) to (064) accomplished in a special dissolver means.

7. The method according to claim 4, wherein
the steps from (011) to (045) accomplished in a regular dissolver means, and
the steps from (051) to (064) accomplished in a special dissolver means.

8. The method according to claim 3, wherein said base stage processing comprising the acts of:
introduction of the processed mixture of fission products (11/12);
drying the processed mixture (011);
removing of gaseous wastes (013) from the processed mixture;
crumpling up the processed mixture to grains substantially of a predetermined size range, obtaining a processed mixture (015);
intermingling the processed mixture with an equal mass of 3% solution of Ca(OH)₂ (021) and kneading it during substantially one hour (022);
filtering the processed mixture (024);
removing liquid wastes (023);
obtaining a filtered processed mixture (025);
intermingling each one mass unit of the filtered processed mixture with two mass units of a 6% water solution of B₂O₃ (031) and kneading the processed mixture during substantially one hour (032);
filtering the processed mixture (034);
removing liquid wastes (033);
obtaining a filtered processed mixture (035);
completely covering the filtered processed mixture the by a 1% solution of chloride of lime Ca(OCl)₂, CaCl₂, Ca(OH)₂ (041) and kneading the mixture during substantially one hour (042);
filtering the processed mixture (044);
removing liquid wastes (043);
obtaining a filtered processed mixture (045);
intermingling the filtered processed mixture with a 3% water solution of H₃BO₃ (051) in a one-to-one proportion and kneading the mixture from 1.5 to 2.0 hours, while keeping the pressure lower than 10 atmospheres (052);
removing liquid wastes (053);
obtaining a product (055);
intermingling each one mass unit of the product with a half mass unit of a 5% water solution of HF (061), and kneading it from 2.5 to 4.0 hours with a maximum pressure limitation of 20 atmospheres (062);
removing liquid wastes (063);
obtaining a technological product (064);
drying the technological product and grinding it to grains of a predetermined size range (071);
introducing the technological product into a special centrifuge means;
processing the technological product in the special centrifuge means being rotated with a velocity of substantially about 16000 rounds per minute during at least 1 hour, not counting the acceleration and deceleration time;
either placing the technological product into glass blocks with the inner dimensions substantially of 50×100×150 mm (091), or subjecting the technological product to compression into blocks with the inner dimensions substantially of 50×100×150 mm followed by covering by a glass-mass or epoxy resin with a layer of at least 3 mm thickness (092); and
placing in storage the blocks resulted from steps (091) or (092) for at least 70-80 years substantially without storage volume limitations under a temperature from +2.degree.C to +60.degree.C.

9. The method according to claim 8, wherein
the steps from (011) to (064) accomplished in a regular dissolver means.

10. The method according to claim 8, wherein
the steps from (011) to (064) accomplished in a special dissolver means.

11. The method according to claim 8, wherein
the steps from (011) to (045) accomplished in a regular dissolver means, and
the steps from (051) to (064) accomplished in a special dissolver means.

12. A special dissolver capable to be utilized for completion of the method according to claim 1, comprising
a cylindrical casing (560);
a first pair of blades (563) capable to revolve around an axis;
a second pair of blades (564) capable to revolve around the axis; wherein casing (560) including an input opening (561) for loading radioactive waste and other components, an output opening (566) for unloading the radioactive waste and the other components, a gaseous waste outlet (562), a liquid fraction outlet (567);
the first pair of blades (563) and second pair of blades (564) disposed in planes perpendicular to each other within the casing (560);
the blades (563) and (564) including electro-conducting wires disposed along the perimeter of each blade; the wires connected to electric current sources so that electromagnetic fields surrounding the blades created inside the special dissolver means.

13. A special centrifuge capable to be utilized for completion of the method according to claim 1, comprising
a casing (80) for loading substances to be processed in the centrifuge, the volume of the casing configured to allow processing a non-critical mass of radioactive waste; the casing preferably shaped as an ellipsoid;
two bearings (84) mounted substantially to the ground;
two semi-shafts (83) mounted in the bearings (84), and positioned preferably along the horizontal axis of the ellipsoid;
said casing (80) coupled to the semi-shafts (83); at least one of the semi-shafts (83) coupled to an electromotor (82), so that the casing (80) capable of revolving with the semi-shafts (83) rotated by the electromotor (82);
two magnetic means (85S) and (85N) facing each other with opposite polarities, mounted so that the magnetic means (85S) and (85N) disposed inside the casing (80) immovable relatively to the ground, and preferably on the opposite ends of horizontal axis of the ellipsoid; and
two partitions (87) installed inside casing (80) separating the magnetic means (85N) and (85S) from the substances subjected to the processing in the centrifuge.

14. The special centrifuge according to claim 13, wherein
the magnetic means (85N) and (85S) coupled to the outer immovable rings of the bearings (84), whereas the semi-shafts (83) coupled to the inner revolving rings of the bearings (84).
